(19) United States
(12) Patent Application Publication
(10) Pub. No.: US 2025/0111015 A1
(43) Pub. Date: Apr. 3, 2025

(54) IMAGE FORMING APPARATUS AND METHOD FOR CONTROLLING THE SAME

(71) Applicant: CANON KABUSHIKI KAISHA, Tokyo (JP)

(72) Inventor: TAKAYUKI TSURUTA, Chiba (JP)

(21) Appl. No.: 18/894,745

(22) Filed: Sep. 24, 2024

(30) Foreign Application Priority Data
Sep. 28, 2023 (JP) 2023-166776

(51) Int. Cl. G06F 21/10; H04N 1/00

(52) U.S. Cl. CPC G06F 21/105; H04N 1/00938

(57) ABSTRACT

An image forming apparatus onto which an application is installable includes one or more memories storing instructions, and one or more processors that are capable of executing the instructions and that, when executing the instructions, cause the image forming apparatus to install the application on the image forming apparatus by using an application file and a license file of the application, and start the application, cause a print server of a region identified based on information about the license file to generate a tenant via a tenant management server, and transmit a first request that the print server associate the generated tenant with the image forming apparatus, to the tenant management server, and transmit a second request that the print server enable a function of the application based on the information about the license file and set a start date of use for each function, to the print server.

### BACKGROUND

### Field of the Disclosure

The present disclosure relates to a setup of an application usable in cooperation with a cloud server, in an image forming apparatus.

### Description of the Related Art

Image forming apparatuses are standardly provided with basic functions such as copy, print, and scan functions. Some image forming apparatuses enable the use of an advanced function through installation of an application after shipment. Increasing numbers of applications have provided higher-performance print and scan functions in cooperation with a cloud service, in particular.

Japanese Patent Application Laid-Open No. 2023-54265 discloses a technique for installing an application that can cooperate with a cloud service intending to improve the sales efficiency of an application to be used on an image forming apparatus.

With many cloud services for implementing the cooperation with an image forming apparatus, including the technique discussed in Japanese Patent Application Laid-Open No. 2023-54265, the user needs to open a tenant, install a dedicated application on the image forming apparatus, associate the image forming apparatus with the tenant, enable functions to be used, and perform other preparation operations.

In starting the use of an advanced function of an image forming apparatus in cooperation with a cloud service, preparation operations are required on both sides of the image forming apparatus and the cloud service. This causes an increase of the burden on installing the advanced function.

### SUMMARY

According to an aspect of the present disclosure, an image forming apparatus onto which an application is installable includes one or more memories storing instructions and one or more processors that are capable of executing the instructions and that, when executing the instructions, cause the image forming apparatus to install the application on the image forming apparatus by using an application file and a license file of the application, and start the application, cause a print server of a region identified based on information about the license file to generate a tenant via a tenant management server, and transmit a first request that the print server associate the generated tenant with the image forming apparatus, to the tenant management server, and transmit a second request that the print server enable a function of the application based on the information about the license file and set a start date of use for each function, to the print server.

Further features of various embodiments will become apparent from the following description of exemplary embodiments with reference to the attached drawings.

### BRIEF DESCRIPTION OF THE DRAWINGS

FIG. 1 illustrates an overall configuration of the present system.

FIG. 2 illustrates a hardware configuration of an image forming apparatus.

FIG. 3 illustrates a hardware configuration of an information processing apparatus.

FIG. 4 illustrates a hardware configuration of a print server and a tenant management server.

FIG. 5 illustrates a software configuration.

FIG. 6 illustrates an example of a data structure of an application file.

FIG. 7 illustrates an example of a data structure of a license file.

FIG. 8 illustrates an example of an application installation screen provided by an image forming apparatus.

FIG. 9 illustrates an example of a sequence according to the present exemplary embodiment.

FIG. 10 is a flowchart illustrating processing for tenant generation and device registration to be performed by the tenant management server.

FIG. 11 is a flowchart illustrating processing for enabling an application function of the image forming apparatus to be performed by the print server.

FIG. 12 illustrates an example of a screen transition between a home screen, a function screen, and an expiration confirmation screen provided by the image forming apparatus.

FIG. 13 is a flowchart illustrating processing for display control to be performed by the image forming apparatus.

FIG. 14 illustrates examples of tables stored in the tenant management server.

### DESCRIPTION OF THE EMBODIMENTS

Exemplary embodiments of the present disclosure will be described below with reference to the accompanying drawings. The following exemplary embodiments do not limit every embodiment within the scope of the appended claims. Not all of the combinations of the features described in the exemplary embodiments are indispensable to the solutions for the present disclosure.

### <Overall System Configuration>

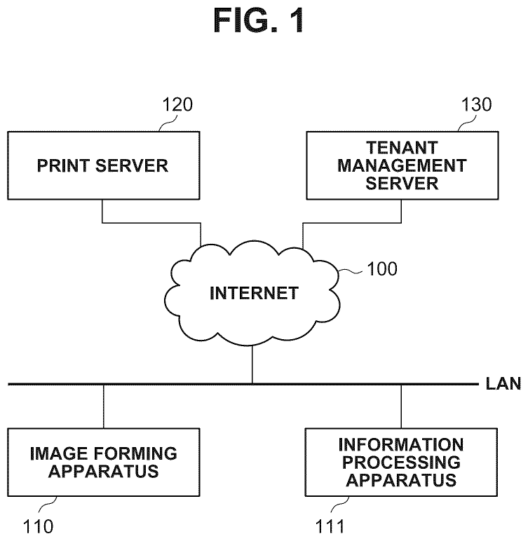

FIG. 1 illustrates an overall configuration of the present system. The system configuration according to the present exemplary embodiment includes an image forming apparatus 110, an information processing apparatus 111, a print server 120, and a tenant management server 130. The image forming apparatus 110 and the information processing apparatus 111 are capable of communicating with servers providing various services on the Internet, via a Local Area Network (LAN). Although FIG. 1 illustrates one image forming apparatus 110 and one information processing apparatus 111, the system may include one or a plurality of image forming apparatuses 110 and one or a plurality of information processing apparatuses 111.

The print server 120 is an online service for cooperating with an application installed on the image forming apparatus 110, transmitting image data generated in scanning by the image forming apparatus 110 to the print server 120, transferring the image data to a service enabling file storage, such as a different storage service, and printing a file of a different storage service and a file and print job transmitted from the information processing apparatus 111 on the image forming apparatus 110. Although FIG. 1 illustrates one print server 120, the system may include the print server 120 for each region for presenting a service.

The tenant management server 130 manages a tenant built by the print server 120. Many cloud services use the same cloud server shared by a plurality of companies and individuals. A tenant refers to a resource unit of a cloud server available to companies and individuals. The tenant management server 130 manages which tenant is present in the print server 120 of which region. Although, according to the present exemplary embodiment, the print server 120 and the tenant management server 130 divide their roles, one server may play the roles of both the print server 120 and the tenant management server 130. While the system configuration according to the present exemplary embodiment includes the image forming apparatus 110, the information processing apparatus 111, the print server 120, and the tenant management server 130, some embodiments are not limited thereto.

### <Hardware Configuration of Image Forming Apparatus>

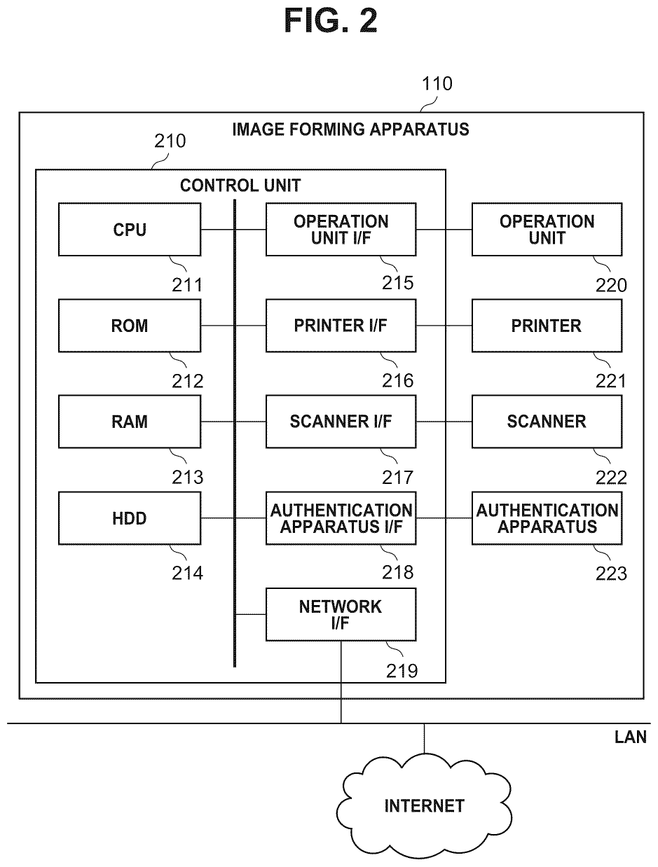

FIG. 2 illustrates a hardware configuration of the image forming apparatus 110. The image forming apparatus 110 includes a control unit 210, an operation unit 220, a printer unit 221, a scanner unit 222, and an authentication apparatus 223. The control unit 210 includes components 211 to 219 (described below) and controls the overall operation of the image forming apparatus 110. A Central Processing Unit (CPU) 211 reads a control program stored in a Read Only Memory (ROM) 212, and executes and controls reading, printing, communication, and other various functions of the image forming apparatus 110.

A Random Access Memory (RAM) 213 is used as the main memory of the CPU 211 and a temporary storage area such as a work area. Although, according to the present exemplary embodiment, one CPU 211 executes processing (described below) by using one memory (the RAM 213 or a Hard Disk Drive (HDD) 214)), some embodiments are not limited thereto. For example, a plurality of CPUs and a plurality of RAMs or HDDs may be cooperatively operated to execute each piece of processing.

The HDD 214 is a mass-storage device for storing image data and various programs. An operation unit interface (I/F) 215 connects the operation unit 220 and the control unit 210. The operation unit 220 having a touch panel and keyboard accepts operations, inputs, and instructions from the user. The printer I/F 216 connects the printer unit 221 and the control unit 210. Image data to be printed is transferred from the control unit 210 to the printer unit 221 via the printer I/F 216 and then printed on a recording medium. The scanner I/F 217 connects the scanner unit 222 and the control unit 210. The scanner unit 222 reads a document placed on a document positioning plate or an Auto Document Feeder (ADF) (not illustrated) to generate image data, and inputs the image data to the control unit 210 via the scanner I/F 217. The image forming apparatus 110 is capable of printing out (coping) the image data generated by the scanner unit 222 from the printer unit 221, and transmitting files or mails. An authentication apparatus I/F 218 connects the authentication apparatus 223 and the control unit 210. The authentication apparatus 223 is, for example, a card reader for reading an Integrated Circuit (IC) card or a fingerprint authentication apparatus for reading a fingerprint. The authentication apparatus 223 is used by the user to authenticate a printer to be used. The network I/F 219 connects the control unit 210 with a LAN. The image forming apparatus 110 transmits image data and information and receives various information to and from each service on the Internet by using the network I/F 219.

### <Hardware Configuration of Information Processing Apparatus>

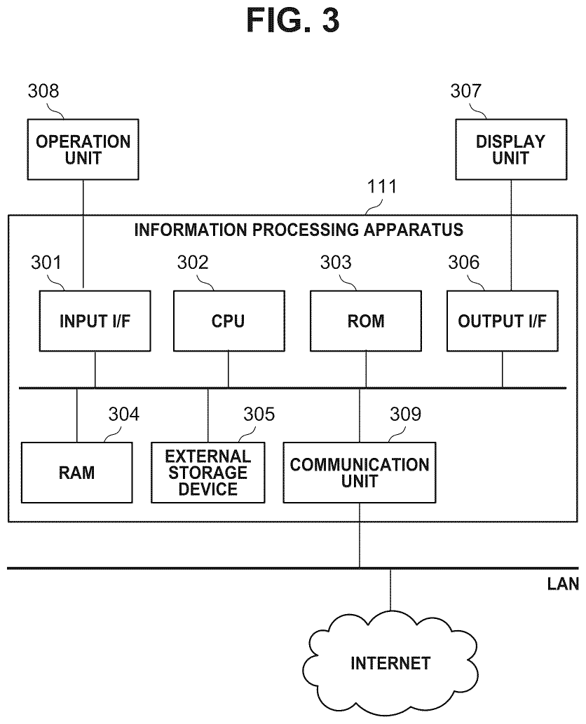

FIG. 3 illustrates an example of a hardware configuration of the information processing apparatus 111. The use of a personal computer (PC) as the information processing apparatus 111 is assumed according to the present exemplary embodiment. However, the information processing apparatus 111 may also be other apparatuses capable of performing network communication, such as a tablet PC (not illustrated).

The information processing apparatus 111 includes an input I/F 301, a CPU 302, a ROM 303, a RAM 304, an external storage device 305, an output I/F 306, and a communication unit 309. The computer of the information processing apparatus 111 includes the CPU 302, the ROM 303, and the RAM 304.

The input I/F 301 detects an input and an operation instruction by the user via an operation unit 308.

The CPU 302 controls the entire system of the information processing apparatus 111 and controls a web browser and other applications.

The ROM 303 stores control programs to be executed by the CPU 302 and fixed data, such as data tables and the built-in Operating System (OS) program. According to the present exemplary embodiment, each control program stored in the ROM 303 controls software execution, such as scheduling, task switching, and interrupt processing under the management of the built-in OS stored in the ROM 303.

The RAM 304 includes a Static Random Access Memory (SRAM) requiring a backup power source. The RAM 304 retains data by using a primary battery (not illustrated) for data backup, and stores important data such as program control variables in a nonvolatile way. The RAM 304 also includes a memory area for storing setting information and management data for the information processing apparatus 111.

The external storage device 305 stores a browser application for operating the image forming apparatus 110 and the print server 120 and displaying screens.

The output I/F 306 displays data on a display unit 307 and notifies of the status of the information processing apparatus 111.

The display unit 307 is an output apparatus including a Light Emitting Diode (LED) display and a Liquid Crystal Display (LCD). For example, the display unit 307 displays the screen of the web browser controlled by the CPU 302.

The operation unit 308 is an input apparatus, such as a keyboard, mouse, and touch panel, for accepting an input from the user. The operation unit 308 may be a physical keyboard or physical buttons, or a software keyboard or software buttons displayed on the display unit 307. More specifically, the operation unit 308 may accept an input operation from the user via the display unit 307.

The communication unit 309 is a component for performing data communication with the image forming apparatus 110 and the print server 120.

### <Hardware Configurations of Print Server and Tenant Management Server>

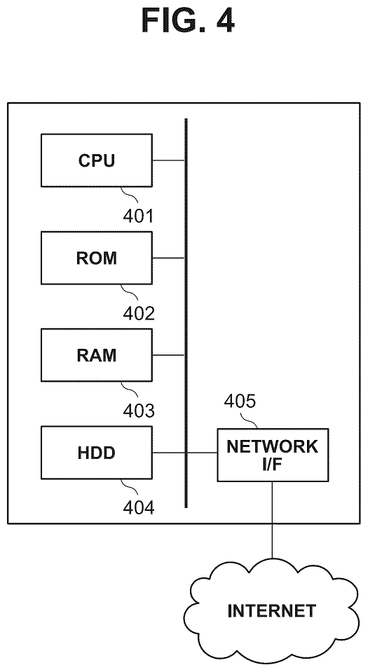

FIG. 4 illustrates an example of a hardware configuration of the print server 120 and the tenant management server 130.

The print server 120 and the tenant management server 130 include a CPU 401, a ROM 402, a RAM 403, an HDD 404, and a network I/F 405.

The CPU 401 reads control programs stored in the ROM 402 and the HDD 404 and executes various processing to control overall operations.

The RAM 403 is used as the main memory of the CPU 401 and a temporary storage area, such as a work area.

The HDD 404 is a mass-storage device for storing image data and various programs.

The network I/F 405 connects to the Internet. The CPU 401 controls data communication with other apparatuses connected to the Internet via the network I/F 405.

### <Software Configuration of Present Exemplary Embodiment>

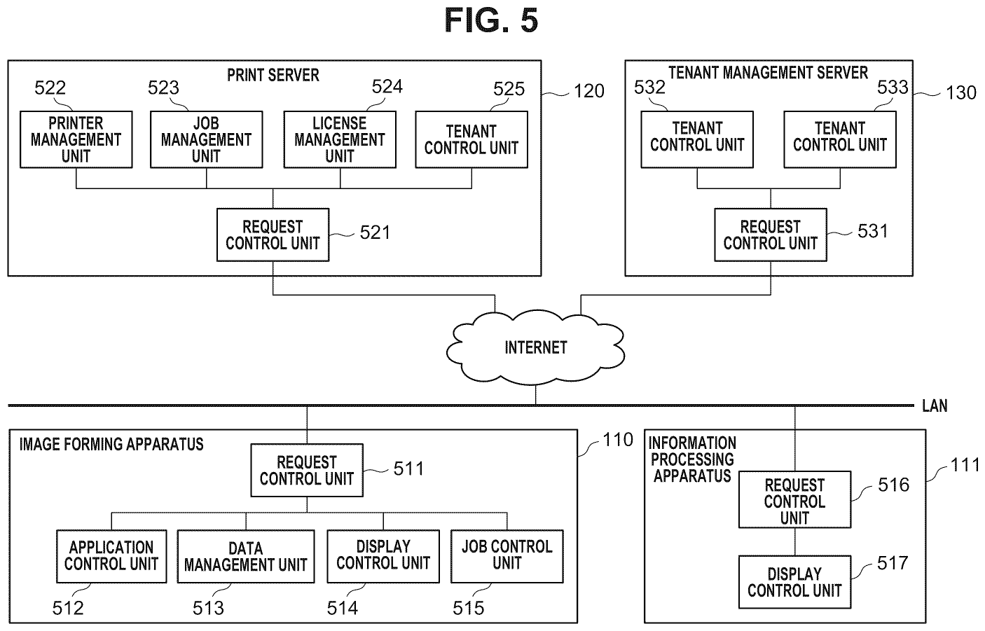

FIG. 5 illustrates an example of a software configuration according to the present exemplary embodiment.

The image forming apparatus 110 includes a request control unit 511, an application control unit 512, a data management unit 513, a display control unit 514, and a job control unit 515. The image forming apparatus 110 communicates data with an external apparatus via the request control unit 511. The application control unit 512 controls installation, activation, and deactivation of an application that operates on the CPU 211 of the image forming apparatus 110. The use of the above-described application is enabled by installing an application file 600 (described below) and a license file 700 (described below) in association with the application file 600. The application file 600 refers to a file storing a program to be executed by the CPU 211 of the image forming apparatus 110. The license file 700 refers to a file or key information including an alphanumeric character string to be used to permit the installation of the application file 600 onto the image forming apparatus 110. The data management unit 513 stores the device serial number of the image forming apparatus 110 in the ROM 212. The device serial number refers to identification information for uniquely identifying the image forming apparatus 110. The display control unit 514 controls a screen to be displayed on the operation unit 220 of the image forming apparatus 110. In response to reception of a request from the web browser operating on another terminal (not illustrated), such as the information processing apparatus 111 or a mobile phone, connected via the Internet, the display control unit 514 returns screen configuration information (Hyper Text Markup Language [HTML], Cascading Style Sheet [CSS]) to be used for screen display. The job control unit 515 executes a print job received from the outside via the request control unit 511 and reads a document placed on the scanner unit 222.

The information processing apparatus 111 includes a request control unit 516 and a display control unit 517. The information processing apparatus 111 receives data and transmits a request to and from other apparatuses via the request control unit 516. The display control unit 517 receives screen configuration information built by the display control unit 514 of the image forming apparatus 110 and controls the screen to be displayed on the display unit 307.

The print server 120 includes a request control unit 521, a printer management unit 522, a job management unit 523, a license management unit 524, and a tenant control unit 525. The print server 120 communicates data with an external apparatus via the request control unit 521. The printer management unit 522 registers a certain image forming apparatus 110 to the print server 120, and manages the registered image forming apparatus 110. The printer management unit 522 can acquire the status, printing performance, scanning performance, and other various settings of the registered image forming apparatus 110. The job management unit 523 receives and manages a print job and a scan job from the print server 120 and the information processing apparatus 111. The job management unit 523 transmits a job to the image forming apparatus 110 managed by the printer management unit 522 in response to a request from the outside. The license management unit 524 manages the enabled states and the availability periods of the functions provided by the print server 120, based on an activation table (described below). The tenant control unit 525 generates a tenant in the print server 120 in response to a request from the outside.

The tenant management server 130 includes a request control unit 531, a tenant control unit 532, and a tenant management unit 533. The tenant management server 130 communicates data with an external apparatus via the request control unit 531. In response to a request from the image forming apparatus 110, the tenant control unit 532 determines a region in which a tenant is added and transmits a tenant generation request to the print server 120 of the region. In response to the request from the image forming apparatus 110, the tenant control unit 532 transmits a request for registration of the image forming apparatus 110 to a certain tenant. The tenant management unit 533 manages a tenant management table (described below) and collectively manages tenants that are present in the print server 120 in all regions in the system according to the present exemplary embodiment.

### <Data Structures of Application File and License File>

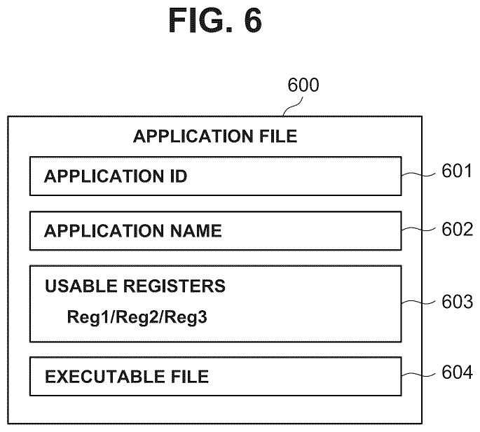

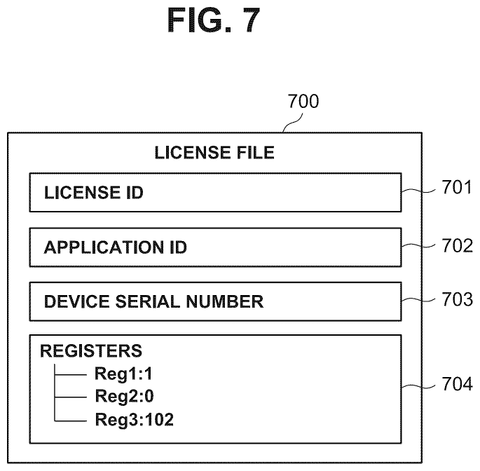

FIGS. 6 and 7 illustrate data structures of the application file 600 and the license file 700, respectively, according to the present exemplary embodiment.

FIG. 6 illustrates an example of a data structure of the application file 600 according to the present exemplary embodiment. The application file 600 includes an application identifier (ID) 601, an application name 602, usable registers 603, and an executable file 604.

The application ID 601 uniquely identifies the application file 600 and includes an alphanumeric character string.

The application name 602 indicates the name of the application.

The usable registers 603 indicate the names of registers in the license file 700 that are referenced by the executable file 604 of the application file 600. Registers refer to values that can be referenced by the executable file 604 of the application file 600. The application can use registers for various purposes. According to the present exemplary embodiment, the application uses registers aiming to define availability period of the function to be provided by the application. Referring to FIG. 6, for example, registers “Reg1”, “Reg2”, and “Reg3” are specified as reference targets. The values to be set to the registers are defined in the license file 700 (described below). Although, according to the present exemplary embodiment, up to three registers are usable, the number of registers is not limited thereto.

The executable file 604 is a program that operates on the image forming apparatus 110. The executable file 604 of the application file 600 may include a plurality of functions.

FIG. 7 illustrates an example of a data structure of the license file 700 according to the present exemplary embodiment. The license file 700 includes a license ID 701, an application ID 702, a device serial number 703, and registers 704. Desirably, the license file 700 is encrypted to prevent alteration by the third party.

The license ID 701 uniquely identifies the license file 700 and includes an alphanumeric character string.

The application ID 702 is the application ID of the application that can be installed with the license file 700. If the license file 700 is in association with the application file 600, the application ID 702 and the application ID 601 are the same value.

The device serial number 703 indicates the device serial number of the image forming apparatus 110 that can be installed with the license file 700.

The registers 704 indicate the values of registers that can be referenced by the executable file 604 of the application file 600. If the application file 600 has a plurality of functions, the operation of the program for each function can be controlled based on the values of the registers 704.

### <Processing>

A description will be provided of processing to be performed by the image forming apparatus 110 in the system according to the present exemplary embodiment in cooperation with the print server 120 and the tenant management server 130. The processing is started when an application is installed. The processing includes generating a tenant, enabling functions included in the application, and controlling the availability period for each function.

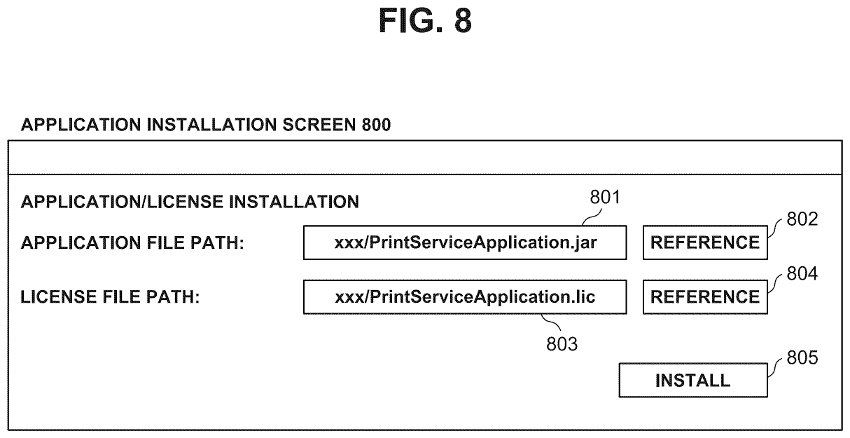

FIG. 8 illustrates an example of an application installation screen 800 built by the display control unit 514 of the image forming apparatus 110. The application installation screen 800 is displayed and operated on a web browser operating on the information processing apparatus 111.

The application installation screen 800 includes an application file path display area 801, an application file reference button 802, a license file path display area 803, a license file selection button 804, and an Install button 805.

The application file path display area 801 displays the file path of the currently selected application file 600. In FIG. 8, for example, “xxx/PrintServiceApplication.jar” is displayed in the application file path display area 801. While, according to the present exemplary embodiment, the application file 600 is a Java Archive (Jar) file, the application file format is not limited thereto.

The application file reference button 802 is used to select the application file 600 to be installed. In response to the depression of the application file reference button 802 having been detected, the display control unit 514 displays a file selection dialog on the display unit 307 to accept a file selection made by the user. The file path of the selected application file is displayed in the application file path display area 801.

The license file path display area 803 displays the file path of the currently selected license file 700. Referring to FIG. 8, for example, “xxx/PrintServiceApplication.lic” is displayed as the file path of the license file 700.

The license file reference button 804 is used to select the license file 700. As in the application file reference button 802, in response to the depression of the license file reference button 804 having been detected, the display control unit 514 displays a file selection dialog to accept a selection of the license file 700 by the user. The file path of the selected license file 700 is displayed in the license file path display area 803.

The Install button 805 is used to start the processing for installing an application onto the image forming apparatus 110 by using the above-described selected application file 600 and the license file 700.

In response to detection of the depression of the Install button 805 by the user, the information processing apparatus 111 transmits an installation instruction to the image forming apparatus 110.

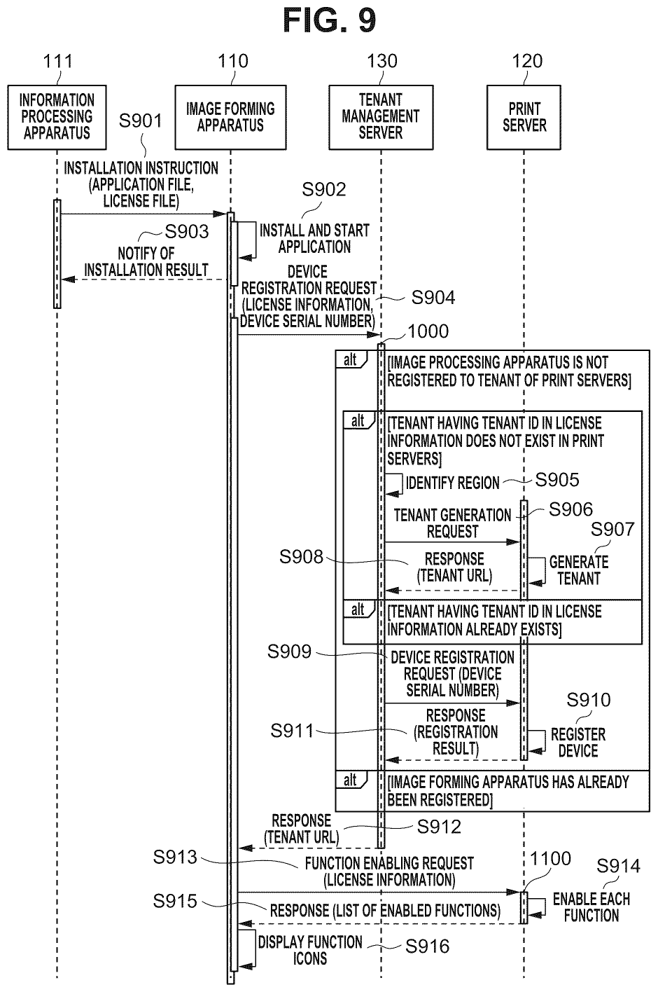

FIG. 9 is a sequence diagram illustrating an example of processing to be performed in the image forming apparatus 110 of the system according to the present exemplary embodiment in response to installation of the application on the image forming apparatus 110. This processing is performed in cooperation between the image forming apparatus 110, the print server 120, and the tenant management server 130. In the present exemplary embodiment, an example will be described in which setup processing for using only “Function A” and “Function B” are to be used in an application that can provide “Function A”, “Function B”, and “Function C” in cooperation with the print server 120.

Processing for installing the application on the image forming apparatus 110 will be described below with reference to FIG. 9 (steps S905 to S911). The sequence illustrated in FIG. 9 is started when a user, such as a service personnel of a vendor, presses the Install button 805 via a web browser operating on the information processing apparatus 111.

In step S901, the information processing apparatus 111 transmits an instruction to install an application to the image forming apparatus 110. In this case, the information processing apparatus 111 transmits the application file 600 and the license file 700 selected in the application installation screen 800 to the image forming apparatus 110.

In step S902, the application control unit 512 of the image forming apparatus 110 performs processing for installing the application by using the application file 600 and the license file 700 received from the information processing apparatus 111 in step S901, and processing for starting the application.

In step S903, the image forming apparatus 110 notifies the information processing apparatus 111 of an installation result. The installation result indicates whether the application file 600 and the license file 700 are suitably in association with each other and whether the installation processing is successfully completed.

While, according to the present exemplary embodiment, an application is installed via the application installation screen 800, which serves as means for installing an application, the means for installing an application on the image forming apparatus 110 is not limited thereto. For example, there is provided a server (not illustrated) for managing the application file 600 and the license file 700 in association with each other. The server issues an identification number in association with the application file 600 and the license file 700. The above-described identification number is input to the web browser operating on the image forming apparatus 110, so that the license control unit 532 may acquire the identification number, download the application file 600 and the license file 700 from the above-described server, and perform the installation processing.

Processing for tenant generation and device registration will be described below. This processing is performed by the tenant management server 130 in cooperation with the print server 120. The tenant management unit 533 of the tenant management server 130 stores the tenant management table (described below), and performs tenant generation and device registration to the print server 120 based on the information stored in the tenant management table.

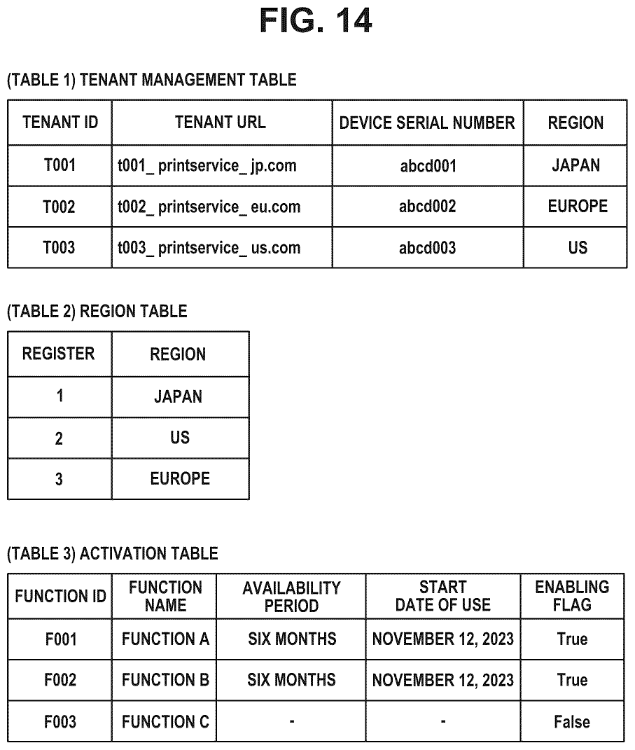

The tenant management table will be described below with reference to Table 1 in FIG. 14. The tenant management table includes a tenant ID column, a tenant Uniform Resource Locator (URL) column, a device serial number column, and a region column. The tenant ID column is an identifier for uniquely identifying the tenant built in the print server 120. The tenant URL column indicates a URL for accessing any tenant of the print server 120. The device serial number column indicates the device serial number of the image forming apparatus 110 cooperating with the above-described tenant. The region column indicates the region of the print server 120 building the above-described tenant. The tenant management table is recorded for each device in cooperation with the print server 120. While the present exemplary embodiment manages these pieces of information with one table, the information may be divided into a plurality of tables.

Referring back to FIG. 9, the tenant management server 130 searches for the information about the license file 700 and the device serial number of the image forming apparatus 110 received with a device registration request from the image forming apparatus 110 (step S904), in the tenant management table. Then, the tenant management server 130 determines whether the image forming apparatus 110 has been registered to a tenant of any print server 120 and determines whether a tenant matched with the tenant ID included in the information about the license file 700 already exists in the print server 120. If the image forming apparatus 110 having the above-described device serial number has not been registered to any tenants of any print server 120 and if the tenant ID included in the information about the license file 700 does not match any tenant ID of any print server 120, the tenant management server 130 and the print server 120 perform operations in steps S905 to S911 (described below). If the image forming apparatus 110 is not registered to any tenant of any print server 120 and there is a tenant of the print server 120 having the tenant ID included in the information about the license file 700, the tenant management server 130 and the print server 120 perform operations in steps S909 to S911 (described below). If the image forming apparatus 110 having the above-described device serial number has been registered to a tenant of any print server 120, the tenant management server 130 does not perform the processing in steps S905 to S911 but performs the processing in step S912. The method with which the tenant management server 130 determines whether the image forming apparatus 110 has been registered to the tenant of any print server 120 and determines whether the tenant matched with the tenant ID included in the information about the license file 700 is present in the print server 120 will be described in detail below with reference to the flowchart 1000.

In step S905, the tenant management server 130 identifies the region of the print server 120 in which the tenant is generated, based on the value of Reg1 of the registers 704 included in the information about the license file 700 acquired in step S904. The method for identifying the region of the print server 120 performed by the tenant control unit 532 of the tenant management server 130 will be described in detail below with reference to the flowchart 1000.

In step S906, the tenant control unit 532 of the tenant management server 130 transmits a tenant generation request to the print server 120 of the region identified in step S905.

In response to the tenant generation request from the tenant management server 130, in step S907, the tenant control unit 525 of the print server 120 generates a new tenant. At this timing, the tenant control unit 525 sets the tenant ID of the tenant to be generated, with an alphanumeric character string that does not overlap with the other tenants.

In step S908, the tenant control unit 525 of the print server 120 transmits the tenant URL and the tenant ID for allowing the generated tenant to communicate with the outside, to the tenant management server 130.

In step S909, the tenant control unit 532 of the tenant management server 130 transmits a device registration request to the tenant of the print server 120. The device registration refers to processing for associating the tenant with the image forming apparatus 110.

In step S910, the printer management unit 522 of the print server 120 registers the image forming apparatus 110 by using the device serial number of the image forming apparatus 110 in the device registration request received from tenant management server 130 (step S909). In step S911, the printer management unit 522 transmits information indicating whether the image forming apparatus 110 has normally been registered, to the tenant management server 130.

In step S912, the tenant control unit 532 of the tenant management server 130 transmits the URL of the tenant of the print server 120 in association with the image forming apparatus 110 which is the source of the device registration request (step S902), to the image forming apparatus 110.

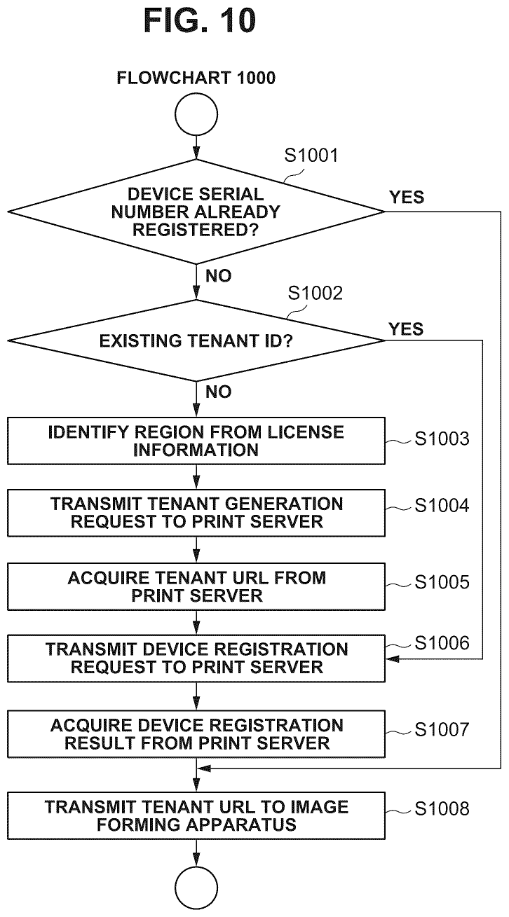

FIG. 10 is the flowchart 1000 illustrating in detail the above-described processing for tenant generation and device registration to be performed on the print server 120 by the tenant management server 130. The flowchart 1000 starts when the tenant management server 130 receives a device registration request (step S904) from the image forming apparatus 110.

In step S1001, the tenant control unit 532 of the tenant management server 130 determines whether the device serial number of the image forming apparatus 110 is present in the device serial number column of the tenant management table, and determines whether the image forming apparatus 110 has been registered to any tenant, by using the above-described tenant management table. In this case, if the tenant control unit 532 determines that the image forming apparatus 110 which is the source of the device registration request (step S904) has been registered to any tenant of the print server 120, the tenant management server 130 does not transmit a request for tenant generation and device registration to the print server 120 but performs the operation in step S1008. If the tenant control unit 532 determines that the device serial number of the image forming apparatus 110 is not present in the tenant management table, and determines that the above-described image forming apparatus 110 is not registered to any tenant of the print server 120, the tenant management server 130 performs operation in step S1002.

In step S1002, the tenant control unit 532 of the tenant management server 130 determines whether to generate a new tenant or associate the image forming apparatus 110 with an existing tenant, based on the values of the registers 704 included in the information about the license file 700 acquired in step S904. According to the present exemplary embodiment, a tenant to be connected to the image forming apparatus 110 can be uniquely specified with an input of the tenant ID to the value of Reg2 of the registers 704. The tenant management server 130 checks whether the value of Reg2 of the registers 704 is present in the tenant ID column of the tenant management table in step S1002. If the value of Reg2 is present in the tenant management table (YES in step S1002), then in step S1006, the tenant management server 130 performs the operation in step S1006 and the subsequent operations. If the value of Reg2 is absent in the tenant ID column of the tenant management table or if the value of Reg2 is “0” (NO in step S1002), then in step S1003, the tenant management server 130 performs the operation in step S1003 and the subsequent operations. For example, since the value of Reg2 of the license file 700 illustrated in FIG. 7 is “0”, the tenant management server 130 performs processing in step S1003 and subsequent steps.

In step S1003, the tenant management server 130 identifies the region of the print server 120 to be subjected to tenant generation, based on the value of Reg1 of the registers 704 included in the information about the license file 700 acquired in step S904. This processing is similar to the processing in step S905 in FIG. 9. According to the present exemplary embodiment, the tenant management unit 533 of the tenant management server 130 stores the region table illustrated in Table 2 in FIG. 14. The region table having the register column and the region column manages the register value and the region of the print server 120 in association with each other. The tenant management server 130 identifies the region of the tenant management server 130 that generates a tenant, by comparing the region table with the value of Reg1 of the registers 704. For example, the value of Reg1 of the license file 700 illustrated in FIG. 7 is “1”. The tenant management server 130 finds a record having this value in the register column of the region table and identifies the region as “Japan”.

In step S1004, the tenant control unit 532 of the tenant management server 130 transmits a tenant generation request to the print server 120 of the region identified in step S1003. In step S1005, the tenant control unit 532 acquires the URL of the tenant generated by the tenant control unit 525 of the print server 120. The operations in steps S1004 and S1005 are similar to those in steps S906 and S908, respectively, in FIG. 9.

In step S1006, the tenant control unit 532 of the tenant management server 130 transmits a device registration request supplied with the device serial number of the image forming apparatus 110 acquired in step S904, to the tenant of the print server 120. In this case, the tenant of the print server 120 to be associated with the image forming apparatus 110 differs according to a determination result in step S1002. If the tenant control unit 532 determines that the value of Reg2 of the registers 704 is already present in the tenant ID column of the tenant management table (YES in step S1002), then in step S1006, the tenant control unit 532 searches for the tenant having the above-described tenant ID in the tenant management table and then transmits a device registration request to the tenant having the tenant ID. If the tenant control unit 532 determines that the value of Reg2 of the registers 704 is absent in the tenant ID column of the tenant management table (NO in step S1002), then in step S1003, the tenant management server 130 transmits a device registration request to the new tenant generated in steps S906 to S908. The operations in step S1006 are similar to those in step S909 in FIG. 9.

In step S1007, the tenant management server 130 receives a result of device registration from the print server 120. The tenant management unit 533 of the tenant management server 130 records the tenant URL, the tenant ID, and the region of the tenant in association with the image forming apparatus 110, and the device serial number of the image forming apparatus 110 in the tenant management table. The operation in step S1007 is similar to that in step S911 in FIG. 9.

In step S1008, the tenant management server 130 searches for the device serial number of the image forming apparatus 110 acquired in step S904 in the tenant management table, and transmits the value of the tenant URL column of the matched record to the image forming apparatus 110. The operation in step S1008 is similar to that in step S912 in FIG. 9.

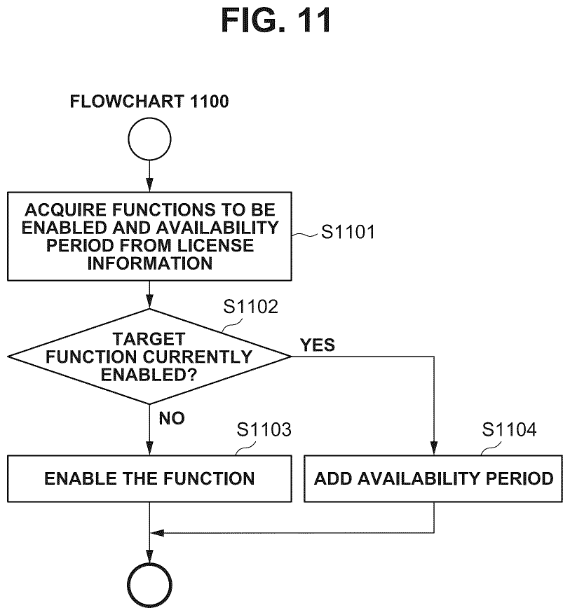

Processing for enabling an application function that operates on the image forming apparatus 110 will be described below with reference to FIG. 9 (steps S913 to S916) and FIG. 11. This processing is performed in cooperation with the image forming apparatus 110 and the print server 120.

In step S913, the application of the image forming apparatus 110 transmits a function enabling request to the print server 120. In this case, the image forming apparatus 110 transmits the values of the registers 704 in the license file 700 together with the request. The destination of transmission from the image forming apparatus 110 is the tenant URL received from the tenant management server 130 in step S912.

In step S914, the print server 120 identifies the application function to be enabled, based on the values of the registers 704 received from the image forming apparatus 110 in step S913, and sets the start date of use of the function. The operation in step S914 performed by the print server 120 will be described in detail below with reference to FIG. 11.

In step S915, the application of the image forming apparatus 110 acquires the values of the enabling flag column of the activation table (described below) from the print server 120.

In step S916, the application of the image forming apparatus 110 displays the function icons of the functions having the “True” value of the enabling flag acquired in step S914, on the operation unit 220.

FIG. 11 is a flowchart 1100 illustrating a processing group started by the print server 120 in response to reception of the function enabling request from the image forming apparatus 110 (step S913).

In step S1101, the license management unit 524 of the print server 120 identifies the functions to be enabled, based on the values of the registers 704 acquired in step S913, and the availability period for each function. According to the present exemplary embodiment, the value of Reg3 included in the registers 704 of the license file 700 indicates the availability period for each function included in the application of the image forming apparatus 110. For example, according to the present exemplary embodiment, the register value represents, as binary data, the effective period for each function. The lower 4 bits define the availability period of the function A, the intermediate 4 bits define the availability period of the function B, and the higher 4 bits define the availability period of the function C. Referring to the license file 700 in FIG. 7, for example, the value of Reg3 is 102 (=0000 0110 0110). The print server 120 acquires this value in step S1101. The availability period of each function can be obtained by dividing this value by 4 bits. The availability periods of the functions A, B, and C are “6 (=0110) months”, “6 (=0110) months”, and “0 (=0000) months”, respectively. The print server 120 identifies functions having an availability period of “1 (=0001) month” or longer as enabling targets. Therefore, the functions A and B are to be enabled in the above-described example.

In step S1102, the license management unit 524 of the print server 120 checks whether each function identified as an enabling target in the processing in step S1101 is currently being enabled, by using the activation table (described below).

The activation table will be described below. Table 3 in FIG. 14 indicates an example of the activation table stored by the license management unit 524 of the print server 120. The activation table is present for each tenant of the print server 120, and includes a function ID column, a function name column, an availability period column, a start-date-of-use column, and an enabling flag column. The function ID column indicates the identifier of the function that can be provided by the print server 120 in cooperation with the application of the image forming apparatus 110. The function name column indicates the name of each function. The availability period column indicates the period during which each function is available. This column stores the availability period identified from the value of Reg3 by the license management unit 524 in the operation in step S1101. The start-date-of-use column stores the date when the target function is enabled. The enabling flag column indicates whether each function is currently enabled. Referring to Table 3 “Activation Table” in FIG. 14, for example, “Function A” is enabled on “Nov. 11, 2023”, the availability period of the function A is “Six Months”, and the function A is currently enabled.

The flowchart 1100 in FIG. 11 will be described again below. If the license management unit 524 of the print server 120 determines that the function to be enabled is currently disabled (NO in step S1102), the processing proceeds to step S1103. In step S1103, the license management unit 524 of the print server 120 enables the function to be enabled. In this case, the license management unit 524 of the print server 120 updates the values of the enabling flag column, the start-date-of-use column, and the availability period column of the above-described function in the activation table. For example, if the license management unit 524 performs the operation in step S1103 based on the information about the license file 700, the values of the enabling flag column of the “Function A” and “Function B” records has the “True” value. The license management unit 524 updates the values of the availability period column of the “Function A” and “Function B” records to “Six Months”.

If the license management unit 524 determines that the function to be enabled has already been enabled (YES in step S1102), the processing proceeds to step S1104. In step S1104, the license management unit 524 adds the availability period identified from the value of Reg3 in step S1102 to the value of the availability period column of the function in the activation table. For example, if “Function A” and “Function B” are already enabled and their availability periods are “Three Months” and “Six Months”, respectively, adding the availability period based on the value of Reg3 of the license file 700 results in “Nine Months” and “12 Months”, respectively.

The installation of an application onto the image forming apparatus 110 implements, through the operations in FIGS. 9, 10, and 11, a system for controlling generation of a tenant, enabling of functions included in the application, and the availability period for each function processing started when an application is installed.

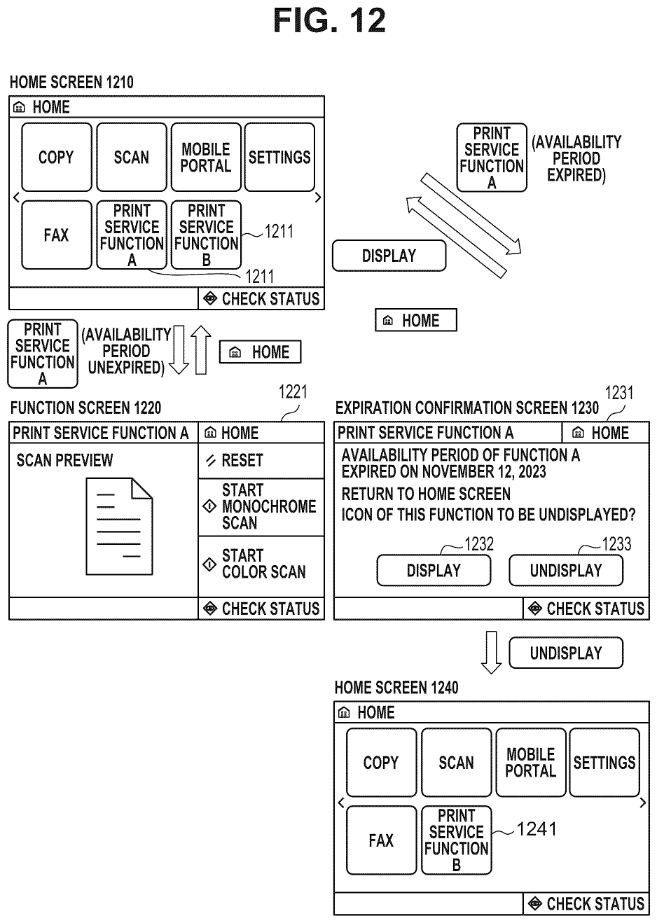

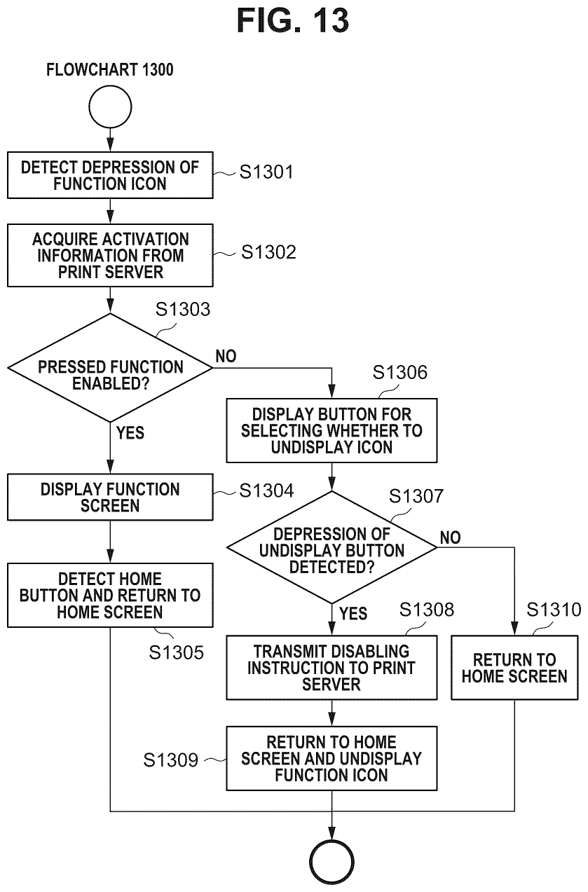

Processing to be performed if a desired function of the application that operates on the image forming apparatus 110 exceeds the availability period will be described below with reference to FIGS. 12 and 13.

FIG. 12 illustrates examples of a home screen 1210, a function screen 1220, an expiration confirmation screen 1230, and a home screen 1240. A flowchart 1300 makes a screen transition between these screens. The screens illustrated in FIG. 12 are configured by the display control unit 514 of the image forming apparatus 110 and displayed on the display unit 220.

The home screen 1210 includes one or more function icons 1211 for activating functions provided by the application of the image forming apparatus 110. Function icons refer to icon buttons assigned to functional units of the application that operates on the image forming apparatus 110.

When the user presses a function icon 1211, the image forming apparatus 110 makes a screen transition to the function screen 1220 for using the function in association with each function icon.

The function screen 1220 allows the use of functions provided by the application of the image forming apparatus 110. The function screen 1220 includes a home button 1221. When the depression of the home button 1221 is detected, the image forming apparatus 110 makes a screen transition to the home screen 1210.

The expiration confirmation screen 1230 appears if the availability period of the function in association with the function icon 1211 pressed in the home screen 1210 has expired. The expiration confirmation screen 1230 includes a home button 1231, a display button 1232, and an undisplay button 1233. When the depression of the home button 1231 is detected, the image forming apparatus 110 makes a screen transition to the home screen 1210. The display button 1232 and the undisplay button 1233 accept a user selection of keeping display of the function icon of each function on the home screen 1210 or undisplay thereof.

The home screen 1240 displays the function icons 1211 as in the home screen 1210. The home screen 1240 is an example of a home screen which undisplays “Print Service Function A” displayed as one of the function icons 1211 in the home screen 1210.

FIG. 13 is the flowchart 1300 illustrating a processing group started in response to depression of a function icon displayed on the display unit 220 of the image forming apparatus 110 according to the present exemplary embodiment.

In step S1301, the application of the image forming apparatus 110 detects the depression of a desired function icon 1211 by the user. In this example, the image forming apparatus 110 detects the depression of the function icon 1211 “Print Service Function A” in step S1301.

In step S1302, for the function in association with the function icon 1211 pressed in step S1301, the application of the image forming apparatus 110 acquires the values of the enabling flag, the start date of use, and the availability period in the activation table from the print server 120.

In step S1303, the application of the image forming apparatus 110 determines whether the availability period of the function pressed in step S1301 has not expired, based on the values of the start date of use and the availability period acquired in step S1302. If the application determines that the availability period of the pressed function has not expired (YES in step S1303), the processing proceeds to step S1304. The image forming apparatus 110 performs processing in steps S1304 and S1305.

In step S1304, the image forming apparatus 110 displays the function screen 1220 of the function detected in step S1301 on the display unit 220.

If the home button 1221 is pressed in the function screen 1220, the processing proceeds to step S1305. In step S1305, the image forming apparatus 110 displays the home screen 1210, and the processing of the flowchart 1300 is ended.

If the application of the image forming apparatus 110 determines that the availability period of the function in association with the function icon pressed in step S1301 has expired (NO in step S1303), the processing proceeds to step S1306. In step S1306, the application displays the expiration confirmation screen 1230. According to the present exemplary embodiment, the application of the image forming apparatus 110 calculates the expiration date of the availability period based on the start date of use and the availability period acquired in step S1302, and displays a message “Availability period of Function A Expired on Nov. 12, 2023. Return to the home Screen. Icon of This Function to Be Undisplayed?”.

In step S1307, the application of the image forming apparatus 110 determines whether the Undisplay button 1233 is pressed in the expiration confirmation screen 1230. In this case, if the application of the image forming apparatus 110 detects that the Undisplay button 1233 is pressed (YES in step S1307), the processing proceeds to step S1308. The application of the image forming apparatus 110 performs steps S1308 and S1309.

In step S1308, the application of the image forming apparatus 110 transmits an instruction for disabling the function in the currently displayed expiration confirmation screen 1230, to the print service 120. Upon reception of the disabling instruction from the application of the image forming apparatus 110, the license management unit 524 of the print service 120 changes the value of the enabling flag of the function in the activation table to “False”.

In step S1309, the image forming apparatus 110 undisplays the function icon 1211 of the function in the home screen 1240. Then, the processing exits the flowchart 1300. The application of the image forming apparatus 110 may undisplay the function icon 1211 immediately after the home screen 1240 appears. Alternatively, processing for undisplaying the function icon 1211 may be reflected after the restart of the image forming apparatus 110.

If the application determines that the home button 1231 or the Display button 1232 is pressed (NO in step S1307), the processing proceeds to step S1310. In step S1310, the image forming apparatus 110 makes a screen transition to the home screen 1210. Then, the processing of the flowchart 1300 is ended.

If the availability period of a desired function of the application operating on the image forming apparatus 110 has expired, the flowchart 1300 prevents the function icon unavailable to the user from being continuously displayed on the home screen.

An installation operation for an application on the image forming apparatus 110 enables easily starting the use of advanced functions of the image forming apparatus 110 using a cloud service.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-166776, which was filed on Sep. 28, 2023 and which is hereby incorporated by reference herein in its entirety.

What is claimed is:

1. An image forming apparatus onto which an application is installable, the image forming apparatus comprising:
one or more memories storing instructions, and
one or more processors that are capable of executing the instructions and that, when executing the instructions, cause the image forming apparatus to:
install the application on the image forming apparatus by using an application file and a license file of the application, and start the application;
cause a print server of a region identified based on information about the license file to generate a tenant via a tenant management server, and transmit a first request that the print server associate the generated tenant with the image forming apparatus, to the tenant management server; and
transmit a second request that the print server enable a function of the application based on the information about the license file and set a start date of use for each function, to the print server.

2. The image forming apparatus according to claim 1, wherein, based on the information about the license file, the region of the print server to be caused to generate the tenant is identified by the tenant management server.

3. The image forming apparatus according to claim 1, wherein the association between the image forming apparatus and the tenant by the print server is executed according to identification information about the image forming apparatus included in the first request transmitted to the tenant management server.

4. The image forming apparatus according to claim 1, wherein, based on the information about the license file, a function to be enabled is determined by the print server and, if the function has already been enabled, an availability period of the function is added by the print server based on the information about the license file.

5. The image forming apparatus according to claim 1, wherein the image forming apparatus displays a function icon of the enabled function, according to information about an enabled state acquired from the print server.

6. The image forming apparatus according to claim 5, wherein, in a case where the function icon is selected on the image forming apparatus, and the availability period of the function in association with the function icon has expired, the function icon is undisplayed.

7. A method in an image forming apparatus onto which an application is installable, the method comprising:
installing the application on the image forming apparatus by using an application file and a license file of the application, and starting the application;
causing a print server of a region identified based on information about the license file to generate a tenant via a tenant management server, and transmitting a first request that the print server associate the generated tenant with the image forming apparatus, to the tenant management server; and
transmitting a second request that the print server enable a function of the application based on the information about the license file and setting a start date of use for each function, to the print server.
